(19) United States
(12) Patent Application Publication
(10) Pub. No.: US 2007/0216064 A1
(43) Pub. Date: Sep. 20, 2007

(54) Customizable mold

(76) Inventor: Benjamin Logan, Oxford, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/725,001

(22) Filed: Mar. 16, 2007

Related U.S. Application Data
(60) Provisional application No. 60/782,713, filed on Mar. 16, 2006.

(51) Int. Cl. B29C 39/00

(52) U.S. Cl. 264/299; 264/571; 425/389; 425/440; 425/383

(57) ABSTRACT

An embodiment of an adjustable molding apparatus includes a substrate including a negative molding surface, a layer of flexible material, and a vacuum source for drawing at least a portion of the flexible material into contact with at least a portion of the negative molding surface.

### CROSS REFERENCE TO RELATED APPLICATIONS

This application claims priority to U.S. Provisional Patent Application 60/782,713 filed Mar. 16, 2006, the disclosure of which is incorporated by reference in its entirety.

### TECHNICAL FIELD

The disclosure generally relates to forming products of a desired shape with a hardenable material.

### BACKGROUND

In the cement casting industry, indicia such as figures or numbers may be molded or etched by varying ways into a cement block or plague. Many buildings incorporate these plaques into their fascia to indicate the street address. A typical method for producing address plagues includes manufacturing a blank cast cement plague and sandblasting the indicia, such as an address, into an outer surface of the plaque. This method may include forming the indicia through the thickness of a rubber mask to form openings, and temporarily adhering the rubber mask to a desired surface of the cement plague then using a sandblaster to etch the numbers into the cement. The sand or grit deflects from the rubber sheet and abrades the surface of the cement through the openings of the desired shape. This method, although commonly used, is labor intensive, and generates airborne particulates that may require respiratory protection and extensive cleanup. Further, sandblasting is often time consuming if deeply etched figures are desired. A method that includes sandblasting does not allow for the reproduction of three dimensional figures in either a positive or negative exposure since it may be difficult to produce a mask that would protect a plague that had an undulating or irregular surface such as a rock or stone. If the rubber mask did not fit in close proximity to the face of the stone, the sand may etch undesired areas of the cement surface.

Another common method to produce cement plagues or signs is to make an exact model of the desired plague complete with all details and then produce a mold from this model. The material commonly used for such a mold is a liquid rubber that can be poured over the model and then solidified to form a flexible rubber mold of the desired negative contour. Cement or other moldable material may be cast into the negative contour of this mold and a plague of the desired detail is produced. Three-dimensional details of a complicated contour may be duplicated for a plurality of products formed from a single mold. However, address plagues for street addresses, would require a new model and mold to be produced for each individual address. These molds are therefore, costly and labor-intensive for the production of such address plagues.

Another popular application for cast cement or concrete is cultured stone which is used in a number of applications such as decorative siding on houses. A typical method to manufacture this man-made stone product is to first make a flexible rubber mold from real stone and then to cast various recipes of concrete into the mold. However, the concrete is abrasive and the method of manufacture is primarily a manual operation. These rubber molds are subject to the wear and abuse from the manufacturing process as the mold is flexed to remove the product, and, therefore, need to be continuously replaced.

Another popular application of cast cement or concrete is the manufacture of accent trims or moldings to replicate those of carved limestone. Here again, it is common practice to make a flexible rubber mold from a master pattern and then cast duplicates from that mold. In the case of custom curves or styles of moldings it may be necessary to create a durable rubber mold that may only be used once and therefore greatly adds to the cost of manufacturing a piece of molding.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 is an exploded view of a portion of a mold according to an embodiment.

FIG. 2 is an exploded view of the portion of the mold of FIG. 1 illustrating additional components.

FIG. 3 is an exploded view of the portion of the mold of FIG. 2 illustrating additional components.

FIG. 4 illustrates the mold of FIG. 1 in a different configuration.

FIG. 5 illustrates the mold of FIG. 1 in a different configuration.

FIG. 6 illustrates the mold of FIG. 1 in a different configuration.

FIG. 7 is a perspective view of a mold according to an embodiment.

FIG. 8 is a sectional view of the mold of FIG. 7, taken generally along line 8-8 of FIG. 7.

FIG. 9 is a sectional view of the mold of FIG. 7 in a ready to cast configuration.

FIG. 10 is a sectional view of the mold of FIG. 7.

FIG. 11 is a sectional view of the mold of FIG. 7.

FIG. 12 is a sectional view of a mold according to another embodiment, taken generally along line 12-12 of FIG. 7.

FIG. 13 is a sectional view of a mold according to a further embodiment.

FIG. 14 is a flow chart illustrating a methodology of molding a product according to an embodiment.

### DETAILED DESCRIPTION

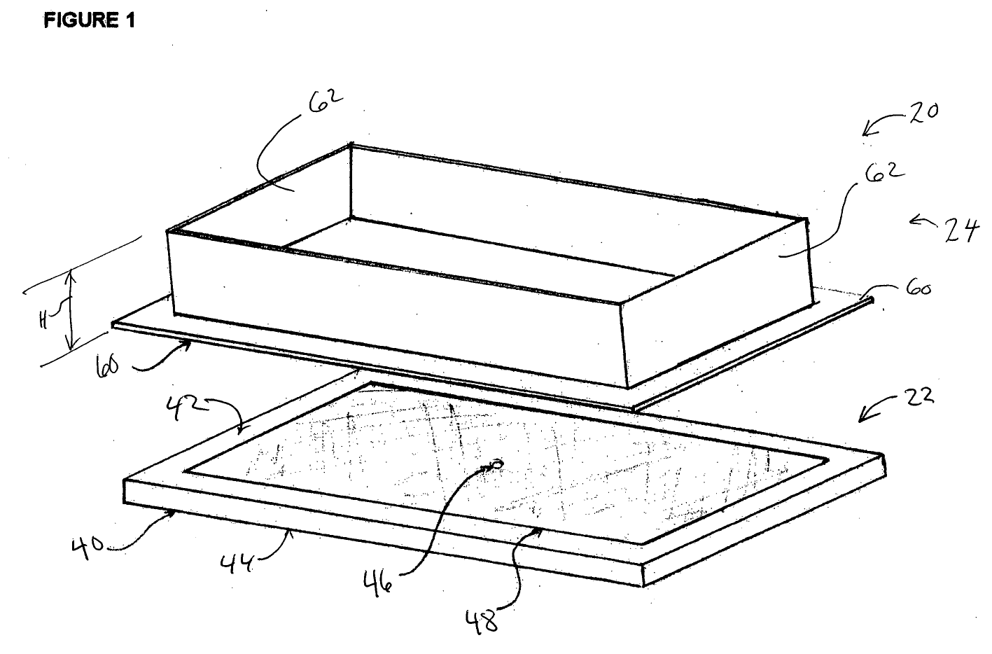

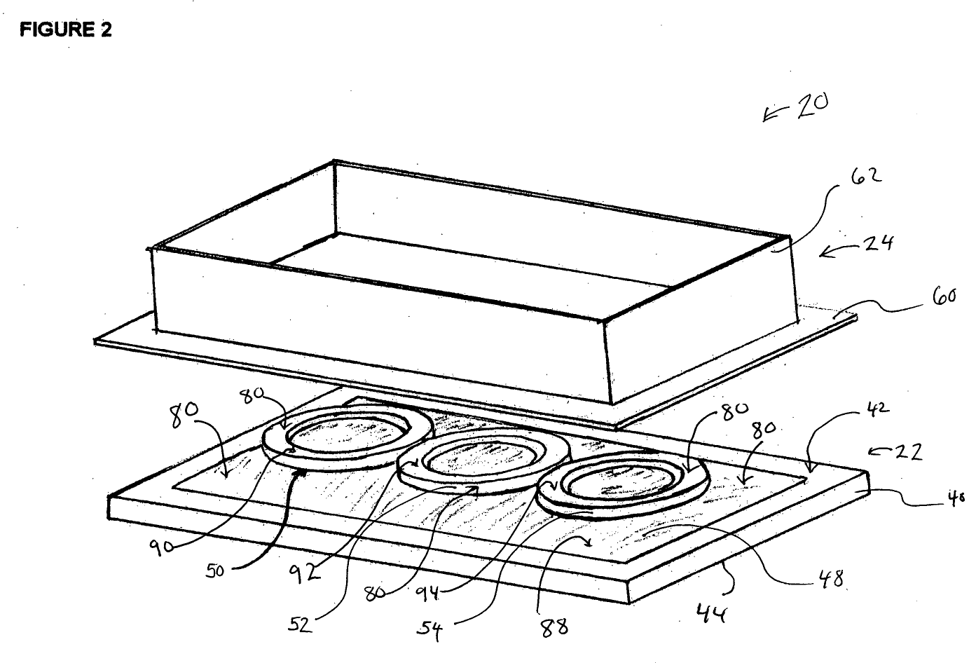

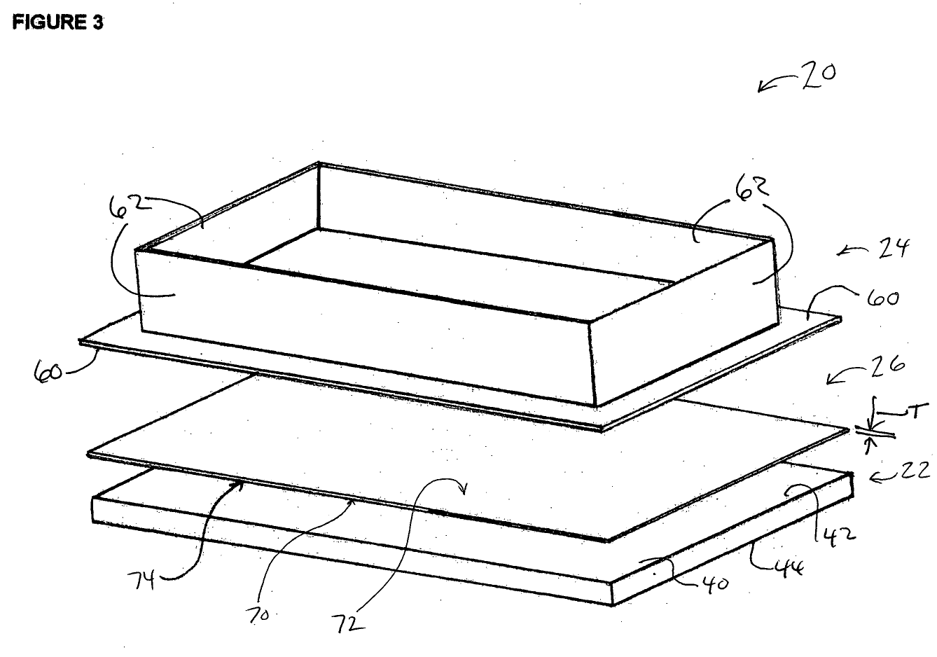

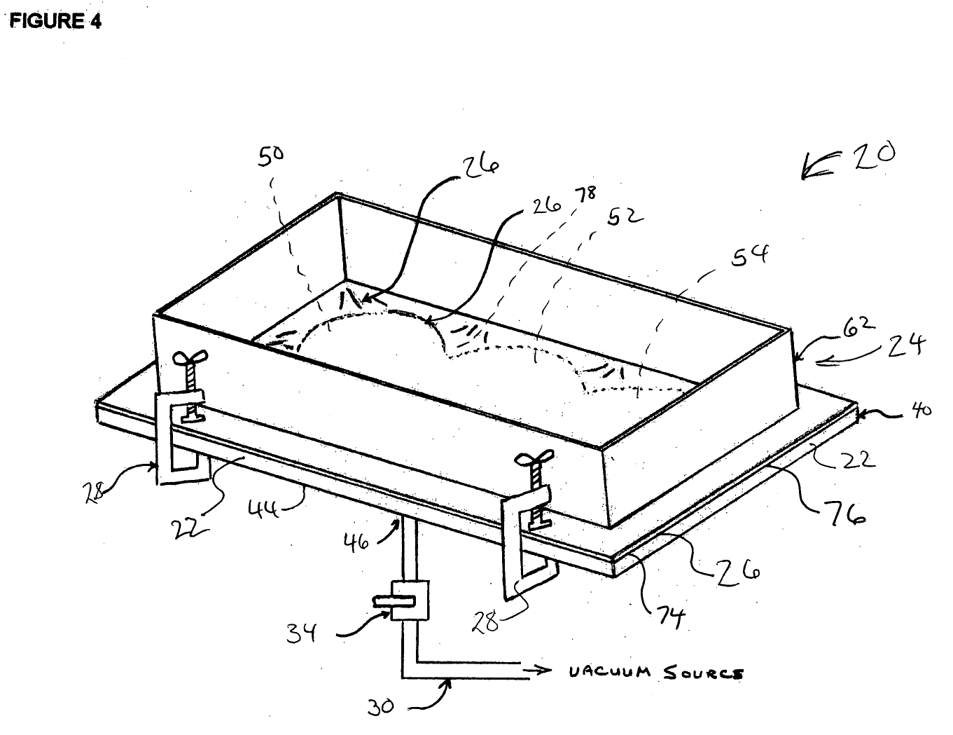

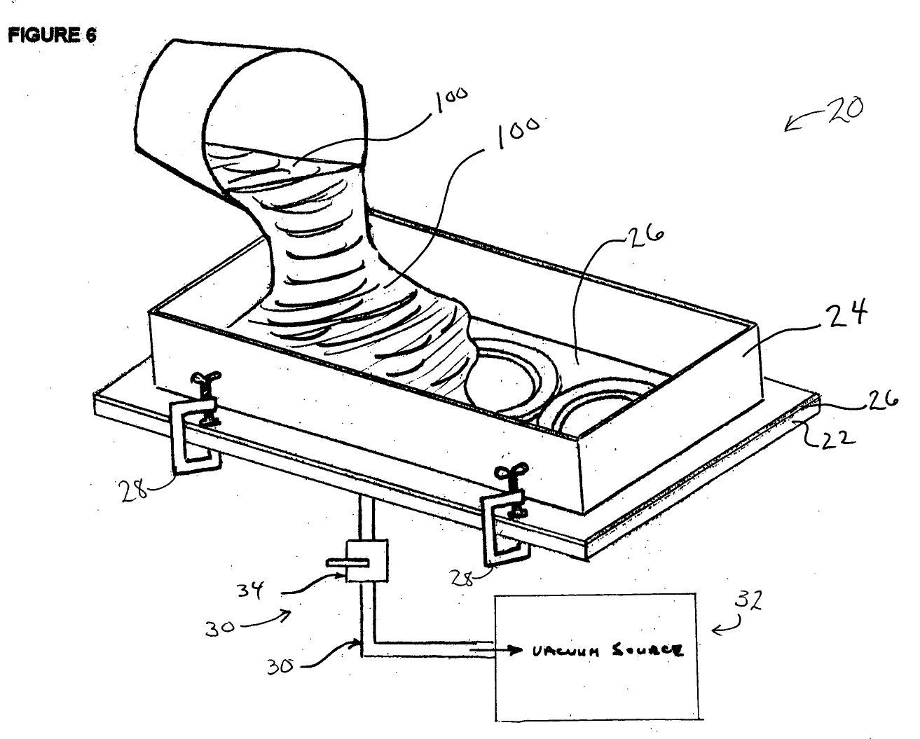

FIGS. 1-6 illustrate a mold 20. The mold 20 includes a substrate 22, a frame 24, a layer 26 (FIGS. 3-6), sealing members 28 (FIGS. 4-6), a purge line 30, and a vacuum source 32 (FIG. 6). The purge line 30 includes a valve 34, as discussed in greater detail below. In the embodiment illustrated, the substrate 22 includes an outer perimeter 40, a top surface 42, a bottom surface 44, and an aperture 46 (FIG. 1) formed therein. The top surface 42 has a portion of cloth, or backing, 48 disposed thereon. As discussed in greater detail below, the backing 48 or other materials may be disposed on the top surface 42 to create a textured surface in a molded product. In the embodiment illustrated, the mold 20 further includes a first insert 50, a second insert 52, and a third insert 54 (FIG. 2), although any number of inserts may be provided.

In the embodiment illustrated, the aperture 46 is formed in the substrate 22 and a fitting (not shown) may be attached. The fitting may be connected to the purge line 30 and the vacuum source 32, as discussed in greater detail below. The backing 48 may allow air and other fluids to flow therethrough and may be adhesively attached to the top surface 42. The backing 48 may be a smooth material such as felt to yield a smooth finish on a molded product, or the cloth may be a textured material such as burlap to yield a textured surface on the molded product.

The frame 24 includes a periphery 60, and an outer wall 62. The periphery 60 of the frame 24 may be constructed to same dimensions of the base. The frame 24 may be a plywood frame or a metal frame or other suitable material. The height H (FIG. 1) of the frame 24 is provided to accommodate the thickness of the molded product, as discussed below.

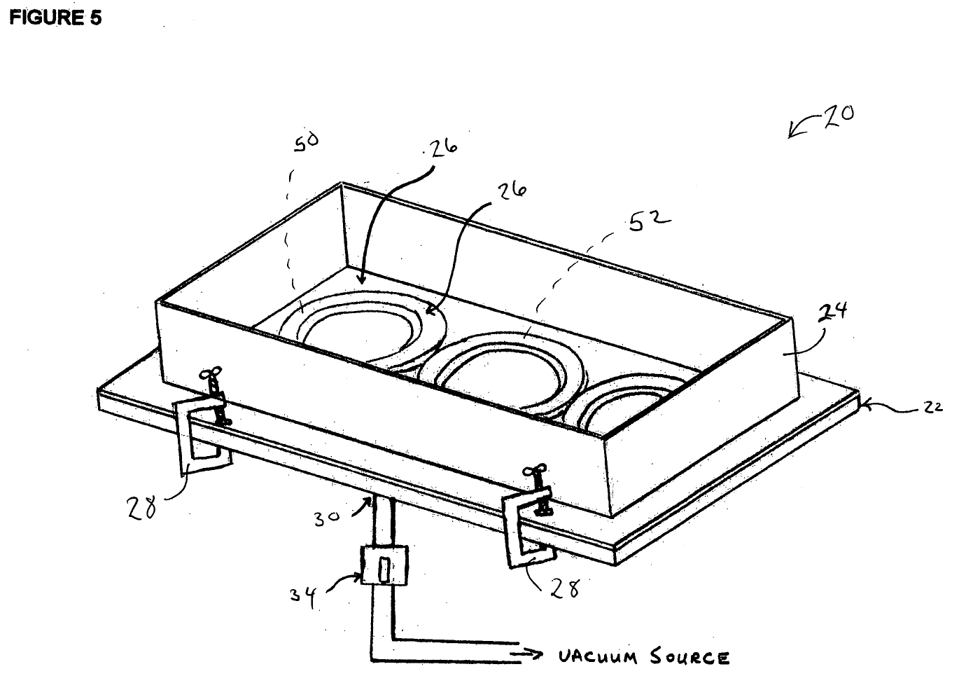

The layer 26 includes a first surface 70, a second surface 72, and an outer layer periphery 74 (FIG. 3). As best illustrated in FIGS. 4 and 5, the layer periphery 74 is selectively interposed between the periphery 60 and the perimeter 40 and the sealing members 28 are coupled to the mold 20 such that the portion of the layer 26 defined by the first surface 70 and the layer periphery 74 is sealed to the perimeter 40 to produce a seal 76 (FIGS. 4-6). Also as best illustrated in FIGS. 4 and 5, the portion of the mold 20 facing the first surface 70 defines a mold volume 78. That is, the mold volume 78 is a volume that may be sealed from the ambient environment of the mold 20.

At least a portion of the mold 20 that contacts the first surface 70 is a negative mold surface 80. The contour of the negative mold surface 80 is determined by the forming of the top surface 42 and the addition of items such as the backing 48, the first insert 50, the second insert 52, and the third insert 54. Additionally, the contour of the negative mold surface 80 may be altered by the application of the vacuum source 32 to the mold volume 78, as discussed in greater detail below.

The backing 48, if used, is a portion of the substrate 22 and includes a negative molding surface portion 88. The first insert 50 is a portion of the substrate 22 and includes a first insert negative molding surface 90. The second insert 52 is a portion of the substrate 22 and includes a second insert negative molding surface 92. The third insert 54 is a portion of the substrate 22 and includes a third insert negative molding surface 94.

FIG. 6 illustrates a pourable material 100 being poured into the mold 20. Generally, the pourable material 100 will harden and a molded product (not shown) is removed as a single item.

The substrate 22 may include a urethane, although other materials may be used, as described herein. As best seen in at least one of FIGS. 3-6, the layer 26 includes a generally constant thickness T (FIG. 3) of between about 0.008 inches and about 0.030 inches. The substrate 22 may also be formed of a non-permeable material such as polyvinyl chloride (PVC) or a permeable material such as plywood or medium density fiberboard that has been sealed to render it generally non-permeable to air. A thickness of the substrate 22 of ½ inch to 1 inch is used in the illustrated embodiment, although the thickness of the substrate 22 may depend upon the length and width, of the substrate 22.

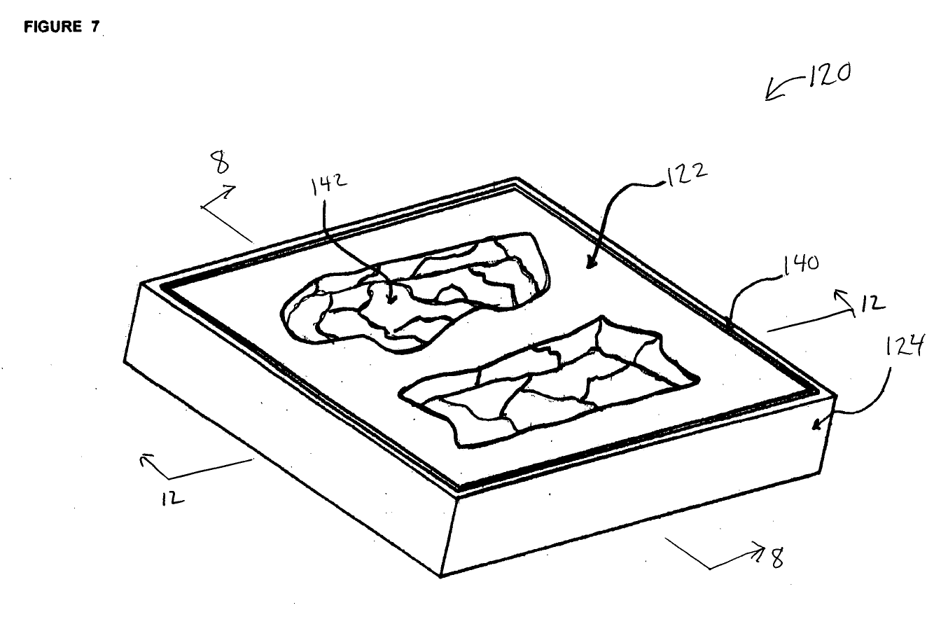

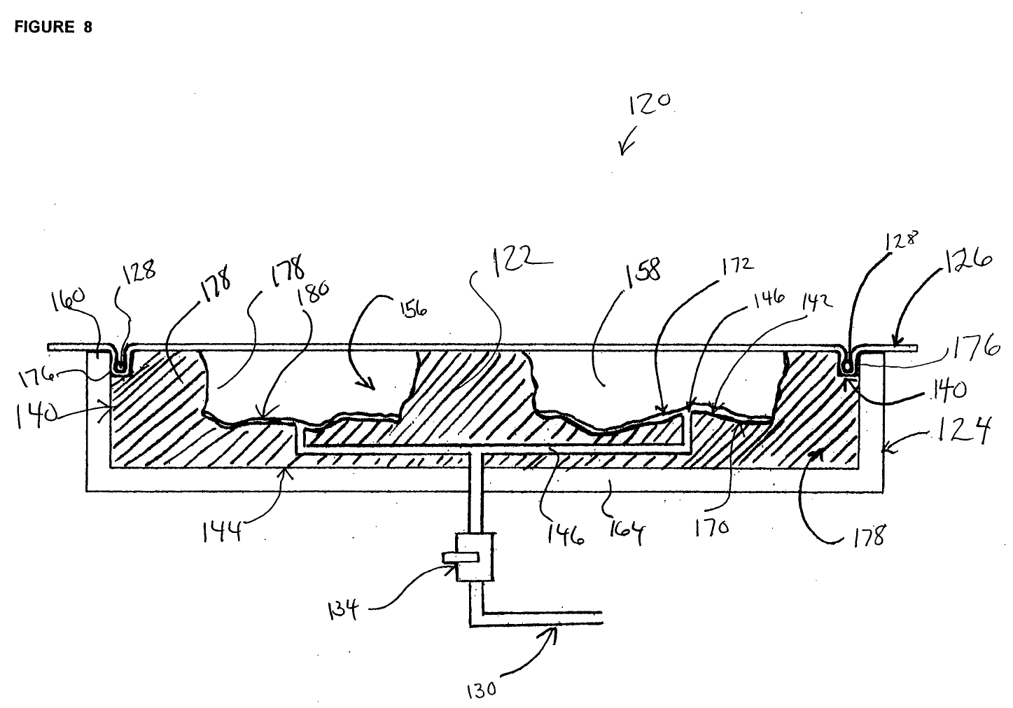

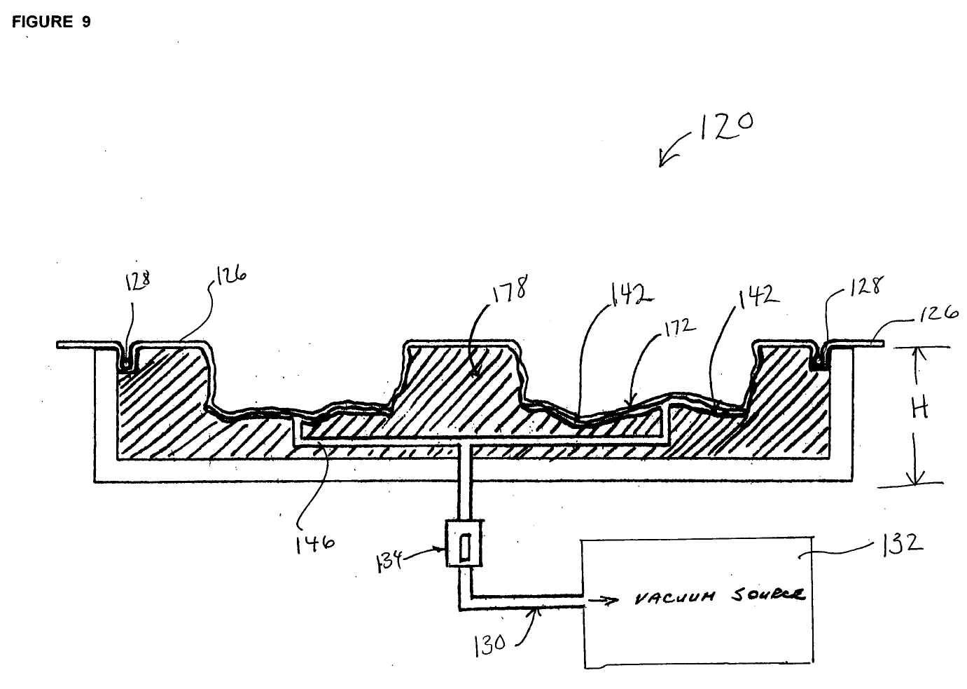

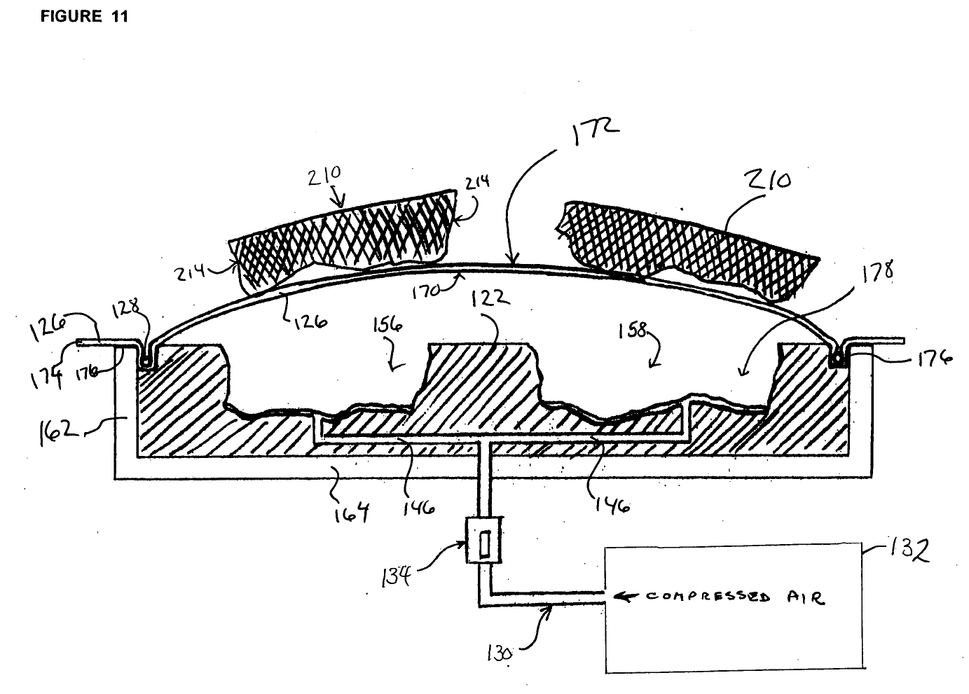

With reference to FIGS. 7-11, a mold 120 is illustrated. The mold 120 includes a substrate 122, a frame 124, a layer 126 (FIGS. 8-11), sealing members 128 (FIGS. 8-11), a purge line 130, and a vacuum source 132 (illustrated schematically in FIG. 9) and a fluid source 136 (illustrated schematically in FIG. 11). The purge line 130 includes a valve 134. In the embodiment illustrated, the substrate 122 includes an outer perimeter 140, a top surface 142, a bottom surface 144, a channel 146 formed therein, a first cavity 156 and a second cavity 158.

The frame 124 includes a periphery 160, an outer wall 162, and a base 164. The periphery 160 of the frame 124 may be constructed to same dimensions of the base. The frame 124 may be a plywood frame or a metal frame or other suitable material. The height H (FIG. 9) of the frame 124 is provided to accommodate the thickness of the substrate 122.

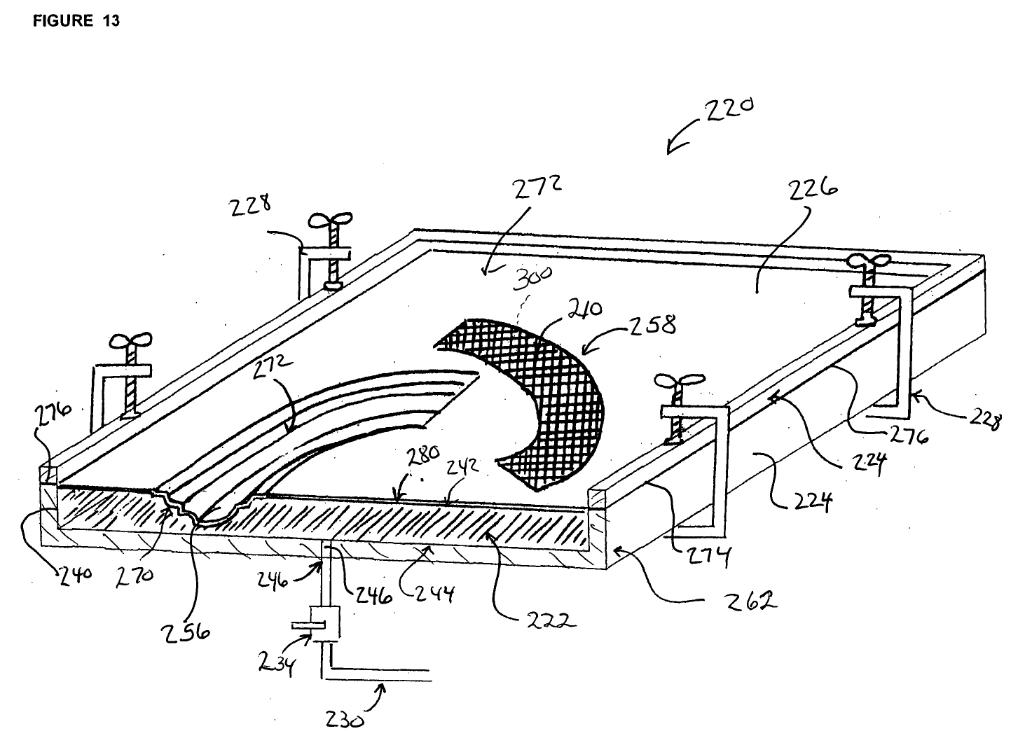

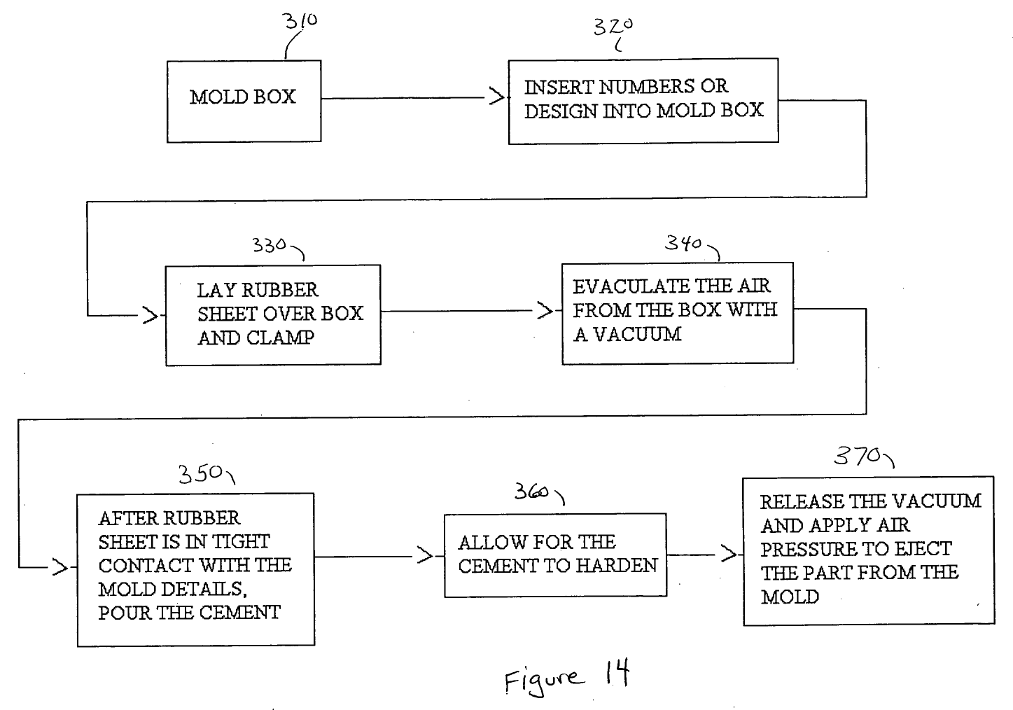

The layer 126 includes a first surface 170, a second surface 172, and an outer layer periphery 174 (FIG. 13). As best illustrated in FIGS. 14 and 15, the layer periphery 174 is selectively interposed between the periphery 160 and the perimeter 140 and the sealing members 128 are coupled to the mold 120 such that the portion of the layer 126 defined by the first surface 170 and the layer periphery 174 is sealed to the periphery 160 to produce a seal 176 (FIGS. 8-11). Also as best illustrated in FIGS. 8 and 9, the portion of the mold 120 facing the first surface 170 and residing within the frame 124 defines a mold volume 178. That is, the mold volume 178 is a volume that may be sealed from the ambient environment of the mold 120 where the mold volume 178 of FIG. 8 is defined by a greater volumetric value (includes the volume of the cavities 156, 158) than the mold volume illustrated in FIG. 9.

At least a portion of the mold 120 that contacts the first surface 170 is a negative mold surface 180. The negative molding surface 180 defines a contoured pattern where at least a portion of the first surface 170 is selectively in contact with at least a portion of the negative molding surface 180. As illustrated, the frame 124 is generally air-tight, and the substrate 122 may be porous, as the frame 124 and the layer 126

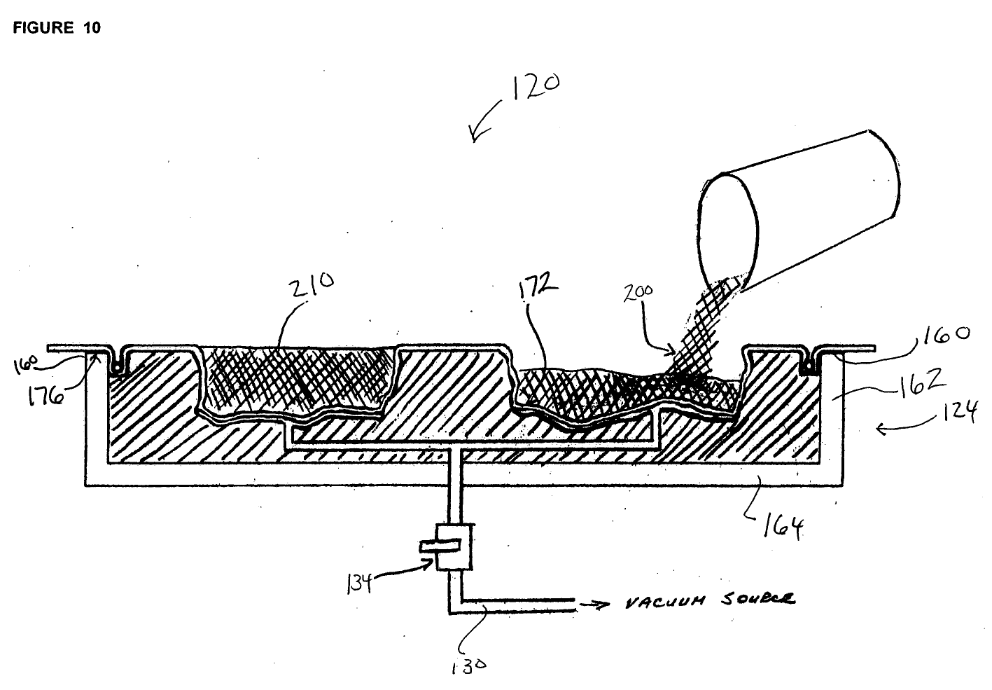

FIG. 10 illustrates a pourable material 200 being poured into the mold 120. Generally, the pourable material 200 will harden and a molded product 210 (FIG. 11) is removed as a single item. FIG. 11 illustrates an embodiment of releasing the product 210 from the mold 120.

In the embodiment illustrated, the channel 146 is formed in the substrate 122 and a fitting (not shown) may be attached. The fitting may be connected to the purge line 130 and the vacuum source 132, as discussed in greater detail below. The top surface 142 may be textured with a contoured pattern, as desired, to impress a representative contoured pattern 214 on the product 210, as discussed herein. That is, briefly, the layer 126 is sufficiently thin and flexible to deform such that the second surface 172 closely contours the top surface 142 when the vacuum source 132 is applied, resulting in a product, such as the product 210, that bears an impression of the second surface 172 that essentially is a negative of the top surface 142.

The fluid source 136 is for directing a second fluid (gas or liquid) between the layer 126 and the substrate 122 for releasing the product 210. That is, the mold volume 178 may be inflated so as to cause the layer 126 to expand and force the product 210 away from the negative mold surface 142, 180, as best seen in FIG. 11. The fluid source 136 may be an air compressor, a reversible vacuum pump 132, or any other suitable source of fluid. Further, the second fluid may be heated or cooled, as desired to encourage the release of the product 210 or reduce damage to the mold 120.

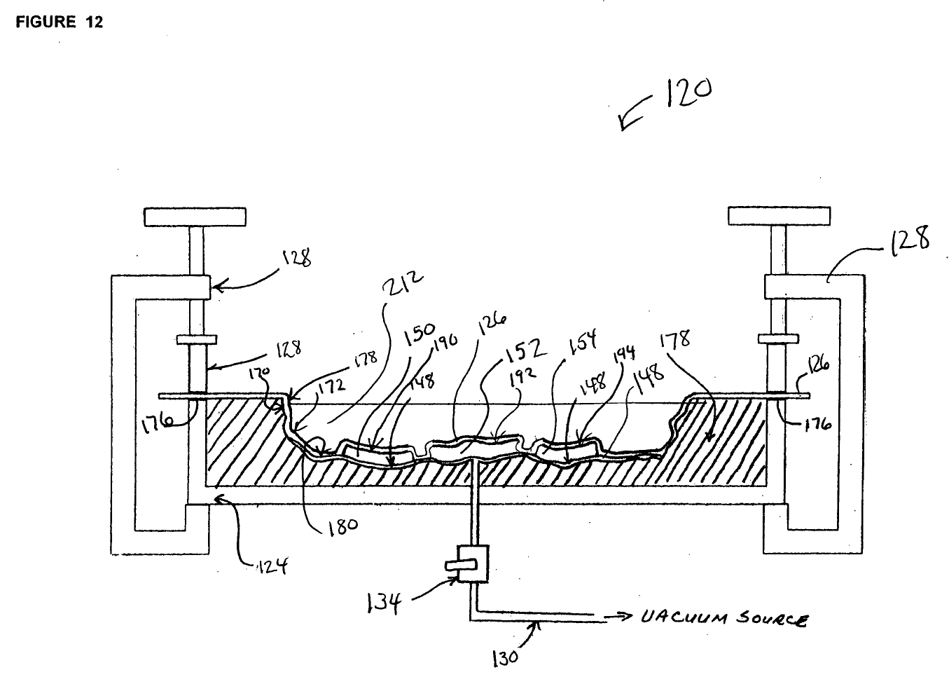

FIG. 12 shows a rubber mold for a cultured stone ready to cast complete with a number or figure that will show in the completed stone face. The mold of FIG. 12 is the mold 120 of FIGS. 7-11 with a portion of cloth, or backing, 148 disposed on the top surface 142. As discussed in greater detail below, the backing 148 or other materials may be disposed on all or only a portion of the top surface 142 to create a textured surface in a molded product. In the embodiment illustrated, the mold 120 further includes a first insert 15Q, a second insert 152, and a third insert 154, although any number of inserts may be provided. The mold 120 is also illustrated in FIG. 12 with a second molded product 212 formed therein.

The contour of the negative mold surface 180 is determined by the forming of the top surface 142 and the addition of items such as the first insert 150, the second insert 152, and the third insert 154. Additionally, the contour of the negative mold surface 180 may be altered by the application of the vacuum source 132 to the mold volume 178, as discussed in greater detail below.

The first insert 150 is a portion of the substrate 122 and includes a first insert negative molding surface 190. The second insert 152 is a portion of the substrate 122 and includes a second insert negative molding surface 192. The third insert 154 is a portion of the substrate 122 and includes a third insert negative molding surface 194.

As will be appreciated, the mold 120 may be used to produce cultured stone products with textures that resemble genuine stone, while extending the life of the substrate 122. The mold 120, when a deformable material such as polyethylene is used as the substrate 122, is readily deformable to release the product 210, 212 while providing a sufficiently rigid mold while under a vacuum for producing a series of products 210, 212 with generally constant dimensions.

FIG. 13 shows a cross-section of a perspective view of a mold 220 for casting custom trims and moldings. The mold 220 includes a substrate 222, a frame 224, a layer 226, sealing members 228, a purge line 230, and a vacuum source (not shown) and a fluid source (not shown). The purge line 230 includes a valve 234. In the embodiment illustrated, the substrate 222 includes an outer perimeter 240, a top surface 242, a bottom surface 244, a channel 246 formed therein, a first cavity 256 and a second cavity 258.

The frame 224 includes a periphery 260, an outer wall 262, and a base 264. The periphery 260 of the frame 224 may be constructed to same dimensions of the base. The frame 224 may be a plywood frame or a metal frame or other suitable material. The height H of the frame 224 is provided to accommodate the thickness of the substrate 222.

The layer 226 includes a first surface 270, a second surface 272, and an outer layer periphery 274. The layer periphery 274 is selectively interposed between the periphery 260 and the perimeter 240 and the sealing members 228 are coupled to the mold 220 such that the portion of the layer 226 defined by the first surface 270 and the layer periphery 274 is sealed to the periphery 260 to produce a seal 276. The portion of the mold 220 facing the first surface 270 and residing within the frame 224 defines a mold volume 278.

At least a portion of the mold 220 that contacts the first surface 270 is a negative mold surface 280. The negative molding surface 280 defines a contoured pattern where at least a portion of the first surface 270 is selectively in contact with at least a portion of the negative molding surface 280. As illustrated, the frame 224 is generally air-tight, and the substrate 222 may be porous, as the frame 224 and the layer 226

A pourable material 300 may be poured into the mold 220. Generally, the pourable material 300 will harden and a molded product 210 is removed as a single item. In the embodiment illustrated, the channel 246 is formed in the substrate 222 and a fitting (not shown) may be attached. The fitting may be connected to the purge line 230 and the vacuum source, as discussed in greater detail below. The top surface 242 may be textured with a contoured pattern, as desired, to impress a representative contoured pattern on the product 210, as discussed herein. That is, briefly, the layer 226 is sufficiently thin and flexible to deform such that the second surface 272 closely contours the top surface 242 when the vacuum source is applied, resulting in a product, such as the product 210, that bears an impression of the second surface 272 that essentially is a negative of the top surface 242.

The fluid source is for directing a second fluid (gas or liquid) between the layer 226 and the substrate 222 for releasing the product 210. That is, the mold volume 278 may be inflated so as to cause the layer 226 to expand and force the product 210 away from the negative mold surface 242, 280, as best seen in FIG. 21. The fluid source may be an air compressor, a reversible vacuum pump 232, or any other suitable source of fluid. Further, the second fluid may be heated or cooled, as desired to encourage the release of the product 210 or reduce damage to the mold 220.

FIG. 14 is a flow chart illustrating a methodology of molding a product with the mold 20. In the illustrated embodiment, a user will assemble the mold generally as in FIG. 4. That is, the user will position the substrate 22 on a relatively flat surface (Step 310), position a backing 48 or other material on the top surface 42, position the first insert 50, the second insert 52, and the third insert 54 on the substrate 22, (Step 320) and position the layer 26 over the substrate 22 so as to interpose backing 48, the first insert 50, the second insert 52, and the third insert 54 between the substrate 22 and the layer 26 (Step 330). The frame 24 may then be coupled to the substrate 22 such that the layer periphery 74 may be sealed with the perimeter 40 (Step 330).

In Step 340, the vacuum source 32 is used to remove fluids, such as air, from the mold volume 78. When the vacuum source 32 has removed a desired amount of a first fluid (fluids within the mold volume 78, such as air) from the mold volume 78 (such as when the layer 26 is sufficiently drawn toward the surfaces 42, 88, 90, 92, 94), the pourable material 100 is poured into the mold 20 in Step 350. In Step 360, the pourable material 100 is allowed to harden or cure, or set, depending upon the material and terminology used. Also in Step 360, the vacuum source may be operated or not operated, to maintain the desired amount of vacuum. Generally, a vacuum of a few pounds per square inch (psi below ambient pressure) is adequate to produce a desirable product. In Step 370, a second fluid is forced through the purge line 30 and into the mold volume to release the product 110, if desired. That is, the inventor has discovered that increasing the pressure within the mold volume, and specifically increasing the pressure between the layer 26 and the surfaces 42, 88, 90, 92, 94, will aid the ‘release’ of the product 110 from the mold 20.

To use the mold 20 for molding a second article (not shown), the second surface 72 of the layer 26 may be cleaned, as desired, and the method is performed as above. Importantly, the layer 26 may be used for multiple products, and when desired, the layer 26 may be replaced at a lower cost than replacing an entire mold. Further, when using a substrate material such as polystyrene, the vacuum will ‘rigidify’ the polystyrene so as to produce a repeatable series of products, while protecting the substrate from damage that may require replacement.

In the embodiment illustrated, the substrate 222 is an extruded polystyrene (PS) such as Styrofoam®, although other materials, such as expanded polystyrene, urethane (such as Vytaflex 50 available from Smooth-On, Inc., 2000 Saint John Street, Easton, Pa. 1804) wood, plastic, polyvinyl chloride (PVC) or rubber may be used. In the use of extruded polystyrene for the substrate 22, the reduction in gasses from the sealed mold 20 due the application of the vacuum may noticeably deform the negative molding surface 42 of the substrate 22. Additionally, a fabric or other material may be placed over a base to form a substrate with a desired texture.

Polystyrene is very easily cut with a hot-wire foam cutter, which may include a heated and taut length of wire. The texture of the resulting surface formed with a hot wire may be dependent upon the speed of the wire, the type of substrate, and the thickness of the substrate.

Although the weight of the pourable material 100 may be sufficient to impress the desired surface contour 80 onto the cured product, the vacuum source 32 will ensure repeatability of the desired surface contour 80 by generally evenly distributing the layer 26 as the vacuum is applied in each successive mold.

As used herein, the term flowable material includes any material that is pourable at any temperature. Additionally, the curing process may include any temperature change or chemical reaction that is associated with a flowable material as the flowable material changes into a state where the flowable material will at least partially take the shape of a mold. As used herein, the term impression refers to a negative likeness thereof.

Also as used herein, the term emboss includes forming a surface contour on an item, where the contour may include a texture or contoured pattern. Also as used herein, the term ambient pressure refers to the atmospheric pressure of the environment surrounding a mold.

Significantly, the pressure on the substrate 22 may be greater than ambient pressure after the material 100 is introduced into the mold 20, depending upon, at least, the weight of the material 100 in the mold 20. However, the removal of the fluids from the mold volume 78 may retain the second surface 72 of the layer into a closely contoured replica of the surfaces 42, 88, 90, 92, 94. The layer 26 can be of varying types of rubber but it is found that latex rubber works well for casting cement. The thickness of the layer 26 used has ranged from 0.008″ to 0.030″. One example of a layer 26 is Latex rubber sheet, (available from suppliers such as McMaster-Carr, item #8611K15, www.mcmaster.com). Other cold casting mediums such as polyurethane may require the use of a silicon rubber sheeting because of its desirable release qualities. The layer 26 will yield more than one casting, even when molding Portland cement, indeed, with proper attention to restricting overstressing or tearing of the layer 26, numerous casting can be produced before a rubber sheet would need to be replaced. As well as rubber sheeting, other elastic films such stretchable food wrap could be used.

In the embodiment illustrated, the pourable material 100 is a mixture of powdered silica, alumina, lime, iron oxide, and magnesia mixed with water to produce a flowable mixture that is produced at room temperature [between about 40° F. (5° C.) and about 85° F. (30° C.)] will harden at about room temperature. Additionally, the cement mixture for use herein may include commercially available additives, as desired. Although the cement described herein includes hydraulic cement (water bearing), other types of cements may be used including those that contain sand, fly ash, (and/or other pozzolan materials) bitumen and/or gypsum. Further, the pourable material 100 may include additives such as accelerators (such as Quix from Ultimax Cement Corp., www.ultimaxcement.com), superplastercizers (such as Adva 555 from W.R. Grace & Co., www.grace.com) and various light weight fillers (such as Perolite®, available from suppliers such as Silbrico Corp., www.silbrico.com).

Although the steps of the method of making the device 20 are listed in a preferred order, the steps may be performed in differing orders or combined such that one operation may perform multiple steps. Furthermore, a step or steps may be initiated before another step or steps are completed, or a step or steps may be initiated and completed after initiation and before completion of (during the performance of) other steps.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A molding apparatus comprising:
a substrate including a negative molding surface;
a layer of flexible material; and
a vacuum source for drawing at least a portion of the layer into contact with at least a portion of the negative molding surface.

2. The apparatus of claim 1, wherein the layer includes a sheet of natural rubber.

3. The apparatus of claim 1, wherein the layer includes a thickness of between about 0.008 inches and about 0.030 inches.

4. The apparatus of claim 1, further comprising a first substrate portion at least partially defined by a first negative molding surface and a second substrate portion at least partially defined by a second negative molding surface, wherein the layer selectively contacts each of the negative molding surface, the first negative molding surface, and the second negative molding surface.

5. The apparatus of claim 4, wherein the layer selectively contours the negative molding surface for molding a product that includes an impression of at least one of the first negative molding surface and the second negative molding surface.

6. The apparatus of claim 1, wherein the substrate includes an expanded polystyrene, an extruded polystyrene, a rubber, a wood, or a composite.

7. The apparatus of claim 1, wherein the negative molding surface includes a contoured pattern, the layer includes a first side and a second side, at least a portion of the first side is selectively in contact with at least a portion of the negative molding surface such that at least a portion of the contoured pattern selectively embosses a representative contoured pattern on the second side.

8. The apparatus of claim 7, further comprising a fluid source for directing a fluid between the layer and the substrate, wherein the representative contoured pattern is selectively formed in a surface of a molded product.

9. A molding apparatus comprising:
a first substrate portion at least partially defined by a first negative molding surface;
a second substrate portion at least partially defined by a second negative molding surface;
a layer of flexible material defining, at least in part, a mold volume; and
a vacuum source for drawing at least a portion of the flexible material into contact with at least a portion of both the first negative molding surface and the second negative molding surface.

10. The apparatus of claim 9, wherein the first substrate portion and the second substrate portion.

11. The apparatus of claim 9, further comprising
a third substrate portion at least partially defined by a third negative molding surface; and
a fourth substrate portion at least partially defined by a fourth negative molding surface, wherein at least a portion of the layer is selectively in contact with at least a portion of the third negative molding surface and the fourth negative molding surface.

12. The apparatus of claim 11, wherein the third substrate portion is at least partially interposed between the layer and the first substrate portion.

13. The apparatus of claim 9, wherein the layer includes a generally constant thickness of between about 0.008 inches and about 0.030 inches.

14. The apparatus of claim 9, wherein the substrate is selectively deformed as the vacuum source removes fluids from the mold volume.

15. A method of forming a molded material comprising:
providing a substrate having a negative molding surface;
positioning a layer of flexible material adjacent the negative molding surface to form a mold volume defined, at least in part, by a first fluid adjacent the negative molding surface;
removing at least a portion of the first fluid to form at least a portion of a mold; and
introducing the flowable material to the mold such that at least a portion of the flexible material is interposed between the flowable material and the negative molding surface.

16. The method of claim 15, wherein positioning the layer of flexible material adjacent the negative molding surface includes sealing a periphery of the layer to a portion of the substrate to seal the volume from an ambient volume.

17. The method of claim 15, wherein removing at least a portion of the first fluid includes applying a vacuum to the negative molding surface to reduce the atmospheric pressure within the mold volume to below ambient pressure.

18. The method of claim 15, further comprising permitting the flowable material to alter such that the flowable material may be removed as a single product.

19. The method of claim 15, further comprising positioning a first substrate portion between the substrate and the layer.

20. The method of claim 15, further comprising interposing a second fluid between the layer and the negative molding surface to release a product from the mold.
